(19) United States
(12) Patent Application Publication
(10) Pub. No.: US 2011/0084033 A1
(43) Pub. Date: Apr. 14, 2011

(54) METHOD AND APPARATUS FOR SEPARATING PARTICLES IN A FLUID

(75) Inventors: Angeles Ivón Rodriguez Villarreal, Monclova (MX); Martin Arundell, Seaford (GB)

(73) Assignee: ONCNOSIS PHARMA AIE, Barcelona (ES)

(21) Appl. No.: 12/933,308

(22) PCT Filed: Mar. 19, 2009
(86) PCT No.: PCT/EP09/53252

§ 371 Date: Dec. 20, 2010

Related U.S. Application Data
(60) Provisional application No. 61/037,805, filed on Mar. 19, 2008.

(51) Int. Cl. B01D 21/00; B01D 43/00

(52) U.S. Cl. 210/774; 210/540; 210/322; 210/253; 210/800; 210/252

(57) ABSTRACT

An apparatus and method for separating particles dispersed in a fluid. The apparatus includes, in succession, an inlet channel, a constriction channel and an outlet channel, the channels configured to receive a fluid dispersion and to create at the junction of the constriction and outlet channels a fluid dispersion flow having a first flow region and a second flow region, wherein the second flow region has a lower concentration of particles than the first flow region. A collection channel is located at the junction of the constriction and outlet channel to collect fluid from the second flow region.

### FIELD OF THE INVENTION

The present invention relate to methods and devices for separating particles dispersed in a fluid.

### BACKGROUND

Structures used in analytical devices have gradually reduced in size to where they are now in the micrometer and even nanometer range. The use of small structures in analytical systems reduces transport times, transport volumes, energy consumption, manufacturing costs etc. The use of microstructures in medical analytical tools has been identified as being particularly useful in near-patient or point of care clinical chemistry diagnostics because of their potential to provide analytical results rapidly. One important clinical application is the separation of cellular components from blood to produce cell free or essentially cell-free plasma that can be measured for clinically relevant constituents, such as proteins.

A number of microfluidic devices for the separation of plasma from blood have been proposed. These devices have typically relied on one of two fluid separation principles; the Zweifach-Fung effect and the Fahraeus effect. The Zweifach-Fung effect describes the flow of red blood cells in a capillary blood vessel where cells tend to travel in the larger flow rate vessel compared to the smaller vessels, where the flow rates are significantly lower. This means that when red blood cells meet a bifurcation region they tend to move into the channel with the faster flow rate, while the blood plasma moves into the lower flow rate channel. An example of a device that uses the Zweifach-Fung effect for separating plasma from blood is described in U.S. Patent Application Publication No. US 2005/0029190. The Fahraeus effect describes the natural tendency of sheared deformable cells to move away from boundaries via hydrodynamic drift. This means that red blood cells flowing through a microchannel tend to migrate away from the wall of the channel to create a plasma layer. Collection of the plasma is achieved by the placement of one or more conduits along the wall of the channel that direct the plasma to a collection point where the sample may be drawn and/or analyzed. The use of constrictions to create local high shear force regions has been shown to increase the thickness of the cell-free plasma layer over a distance of up to one centimeter. A plasma separating device using the Fahraeus effect in conjunction with a constriction is described by Faivre et al., Biorheology 43, 147-159. Another device proposed for separating plasma from blood has used both the Zweifach-Fung effect and the Fahraeus effect in combination with a centrifugal force field, but with failed results. The device is described M. Kersaudy-Kerboas, et al. in “Design, Manufacturing and Test of Disposable Microfluidic System for Blood-Plasma Separation”, Lab on a Chip World Congress Poster (2006).

A common feature among most prior art devices is that they are adapted to process the blood at low fluid flow rates. Moreover, in devices utilizing a constriction, such as that proposed by Kersaudy-Kerboas, et al., the plasma collection channel is always placed at a relatively large distance downstream the constriction. Another common feature among the previous separating devices is that they require pre-processing of the blood, the pre-processing typically including reducing the hematocrit of the blood prior to being introduced into the separating device.

### SUMMARY OF THE DISCLOSURE

In accordance with one aspect of the invention a device for separating particles in a fluid dispersion is provided that comprises an inlet channel and an outlet channel adjoined to one another by a constriction channel, the inlet, outlet and constriction channels configured to create at a junction of the outlet and constriction channels a fluid dispersion flow having a first flow region and a second flow region, the second flow region having a lower concentration of particles than the first flow region; and a collection channel located at the junction of the constriction channel and the outlet channel and having an inlet located within the second flow region of the fluid flow.

In accordance with another aspect of the invention a method of separating particles from a fluid dispersion is provided comprising (a) directing the fluid dispersion successively through an inlet channel, a constriction channel and an outlet channel to create at a junction of the outlet and constriction channels a fluid dispersion flow having a first flow region and a second flow region, the second flow region having a lower concentration of particles than the first flow region; and (b) collecting at least a part of the fluid in the second flow region in a collection channel located at the junction of the constriction channel and the outlet channel.

In accordance with a further aspect of the invention a method of separating particles from blood is provided comprising reducing the hematocrit of a portion of the blood using the Fahraeus effect and Zweifach-Fung effect and, for plasma collection purposes, subsequently separating the remaining blood cells from the blood plasma in the reduced hematocrit portion of the blood using both the Fahraeus and Zweifach-Fung effect. In one embodiment the steps of reducing the hematocrit and separating the blood plasma from the blood cells is performed in a single unitary device.

In accordance with still another aspect of the invention a device for separating particles in a first fluid dispersion is provided that comprises an inlet channel and a flow separation channel adjoined to one another by a first constriction channel, the inlet, flow separation and first constriction channels configured to create at a junction of the flow separation and constriction channels a second fluid dispersion flow having a first dilute flow region and a first concentrate flow region, the first dilute flow region having a lower concentration of particles than the first concentrate flow region, the flow separation channel having a first dilute channel for receiving at least a portion of the first dilute flow and a concentrate channel for receiving at least a portion of the first concentrate flow, the dilute channel having an outlet, the device further comprising a second constriction adjoining the outlet of the first dilute channel with a first outlet channel, the first dilute channel, first outlet and second constriction channels configured to create at a junction of the first outlet and second constriction channels a third fluid dispersion flow having a second dilute flow region and a second concentrate flow region, the second dilute flow region having a lower concentration of particles than the second concentrate flow region; and one or more collection channels having inlets located in the second dilute flow region.

In accordance with another aspect of the invention a method of separating particles from a first fluid dispersion is provided comprising (a) directing the fluid dispersion successively through an inlet channel, a first constriction channel and a separation channel to create at a junction of the separation and first constriction channels a second fluid dispersion flow having a first dilute flow region and a first concentrate flow region, the first dilute flow region having a lower concentration of particles than the first concentrate flow region, the flow separation channel having a first dilute channel for receiving at least a portion of the first dilute flow and a concentrate channel for receiving at least a portion of the first concentrate flow, the dilute channel having an outlet, (b) directing at least a portion of the first dilute flow successively through the dilute channel, a second constriction channel and an outlet channel to create at a junction of the outlet and second constriction channels a third fluid dispersion flow having a second dilute flow region and a second concentrate flow region, the second dilute flow region having a lower concentration of particles than the second concentrate flow region; and (c) collecting at least a portion of the second dilute flow in one or more collection channels located within the second dilute flow region.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1A through 1F show alternative embodiments of a separating device according to the present invention.

FIGS. 2A and 2B are photographs that show the flow conditions at a junction of an outlet channel and constriction channel in a blood separating device at different hematocrit concentrations.

FIGS. 3A and 3B are photographs that show the flow conditions within an outlet channel at different temperatures in a blood separating device.

FIG. 4 illustrates by way of photographs the flow conditions in an outlet and collection channel at different hematocrit and temperature conditions in a blood separating device.

FIG. 5 shows a graph of the temperature affect on the thickness of a plasma flow stream downstream a constriction.

FIG. 6 shows a graph of the flow rate affect on the thickness of a plasma flow stream downstream a constriction.

FIGS. 7A and 7E show alternative embodiments of separating devices according to the invention.

FIGS. 8A through 8C show separating devices of the present invention having multiple constriction and outlet channels.

FIGS. 9A through 9C show other embodiments of a separating device according to the invention.

FIG. 10 is a flow chart of a separating method in one embodiment of the invention.

FIG. 11 is a flow chart of a separating method in another embodiment of the invention.

FIG. 12 is a flow chart of a separating method in yet another embodiment of the invention.

FIG. 13 illustrates by way of photographs the flow conditions in an outlet and collection channel at different flow rates.

FIGS. 14A and 14B illustrate by way of photographs the flow conditions in an outlet and collection channel at different flow rates in another separating device according to the invention.

FIG. 15 illustrates by way of a photograph the flow conditions in an outlet and collection channel in yet another separating device according to the invention.

### DETAILED DESCRIPTION

In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention. It is also important to note that the accompanying drawings are not drawn to scale. Moreover, for discussion purposes, and by way of examples, the following description focuses primarily on separating constituents of blood, and particularly to separating plasma from blood cells. However, it is to be appreciated that the present invention is not limited to fluid dispersions composing blood. The invention is also applicable to other biological fluid dispersions and also to non-biological fluid dispersions. Non-biological applications may, for example, include separating particles in chemical process streams.

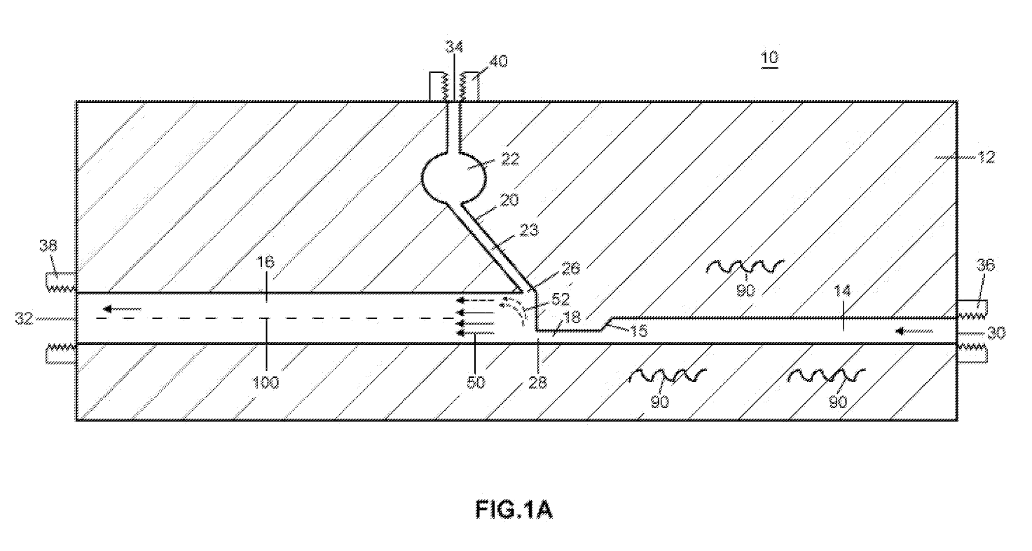

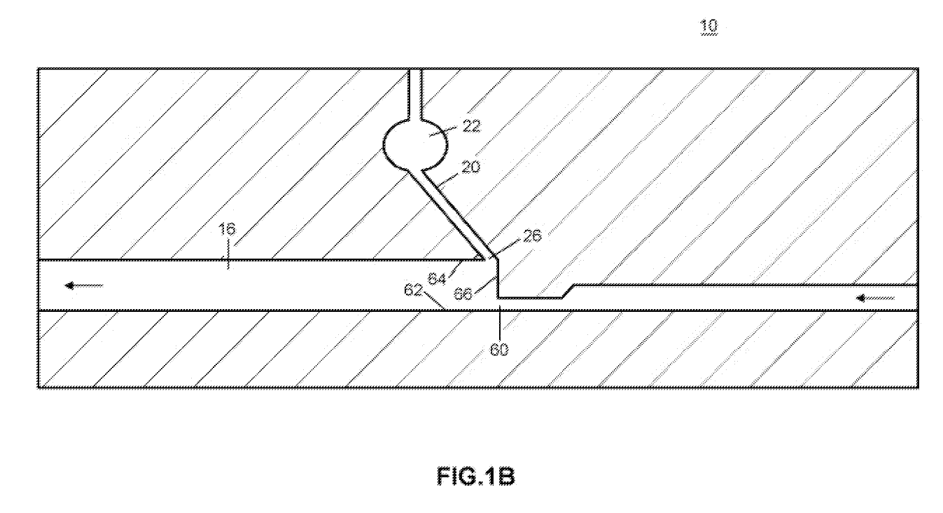

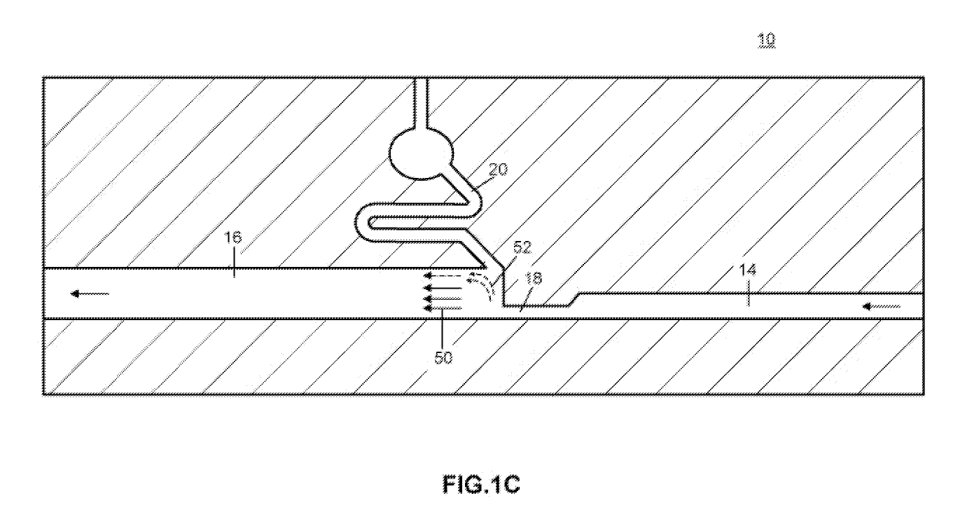

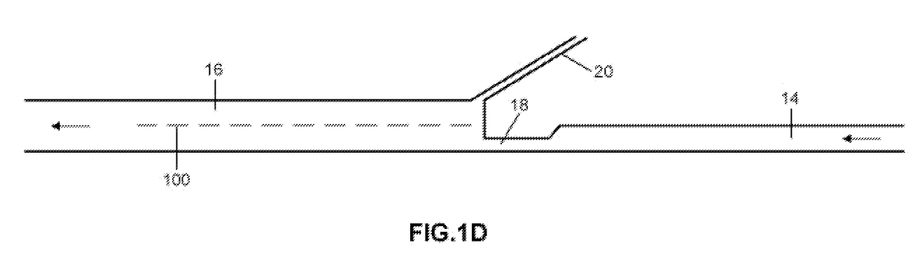

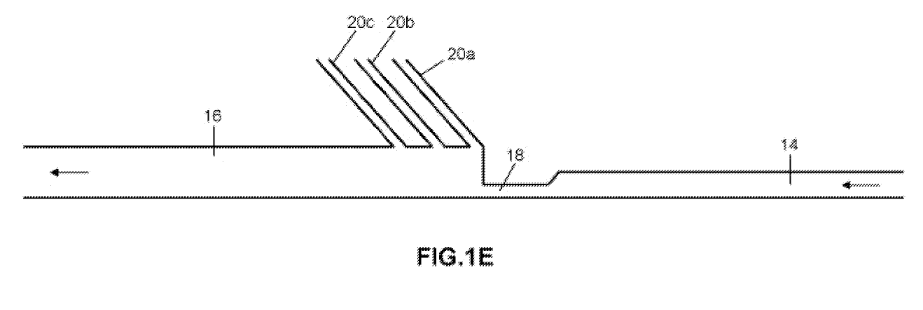

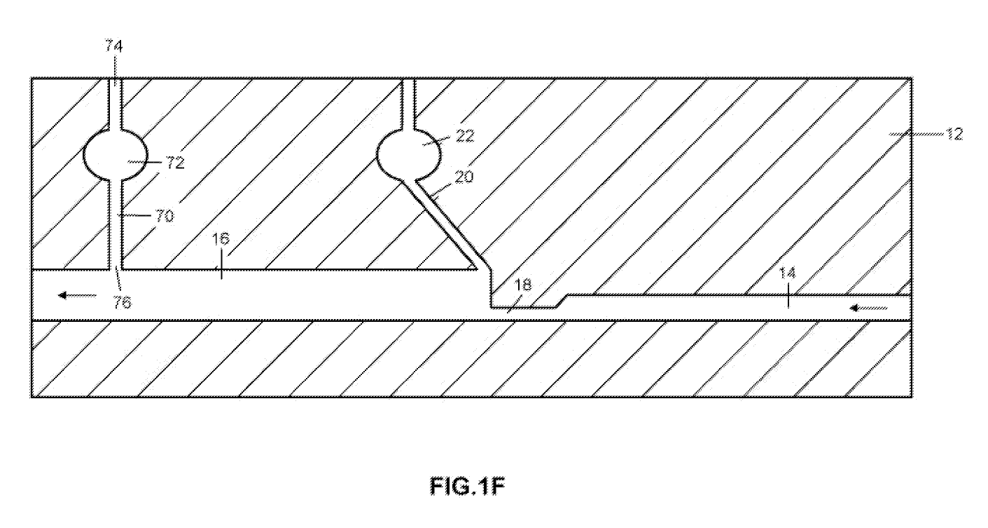

FIG. 1A illustrates a fluid dispersion separating device 10 in one embodiment of the invention. Separating device 10 includes an inlet channel 14 and an outlet channel 16 adjoined by a constriction channel 18 having a cross-sectional area smaller, and preferably significantly smaller, than the cross-sectional area of both the inlet channel 14 and outlet 16. In a preferred embodiment, inlet channel 14 has a tapered or convergent segment 15 of a reduced cross-sectional area at the inlet to the constriction channel 18 to provide a smooth flow transition into the constriction channel. Fluid flow through device 10 is established by inducing a pressure gradient between the fluid dispersion source inlet 30 and the device outlet 32 sufficient to produce a desired flow rate. This can be accomplished by introducing the fluid dispersion into the inlet channel 14 at a pressure higher than the pressure at the device outlet 32 by the use of a pump, syringe or other suitable pressure inducing device or method. In the case of processing blood, the device may be directly attached to the vessel of a patient via a catheter, needle, or other suitable means. For example, during a blood draw from a patient the device 10 is inline with the needle used to access the blood source and the blood is drawn or pushed through device 10 to effectuate separation of selected blood components. Alternatively, flow through the device may be induced by lowering the pressure at the device outlet 32 below that of the fluid dispersion source (not shown) by the use of a vacuum pump, syringe or other vacuum inducing device or method. Fluid flow control devices or pressure regulating devices, such as valves, orifices, etc., may be integrated into one or more of the device flow channels or may be connected to one or more of the device connection points 36, 38 and 40 to provide more precise control of the device operating parameters. To this end, one or more pressure sensors may be incorporated into the device channels. Moreover, as will be discussed in more detail below, temperature sensors may be incorporated into the device for regulating and/or monitoring the temperature of the fluid dispersion.

With continued reference to FIG. 1A, inlet channel 14 has a connector 36 for connecting the device inlet 30 to a fluid dispersion source (not shown). Connector 36, may be a threaded female fitting as shown, or may comprises any of a variety of other well know connectors, such as male fittings, luer fittings, etc. Connectors 38 and 40 located at the egress of the outlet and collection channels, respectively, typically comprise similar type connectors. Based on the Fahraeus effect and Zweifach-Fung effect principles the inlet channel 14, constriction channel 18, and outlet channel 16 are configured to receive the fluid dispersion and to create at the junction 28 of the constriction channel 18 and outlet channel 16 a fluid dispersion flow having a first flow region 50 and a second flow region 52. In the case of processing blood, the first flow region 50 will contain a higher concentration of blood cells than the fluid dispersion in the inlet channel 14, whereas the second flow region will contain a lower concentration of blood cells, and is preferably cell-free or essentially cell-free plasma. A collection channel 20 having an inlet 26 located at the junction 28 of the constriction and outlet channels is configured to receive at least a portion of the fluid in the second flow region 52. A reservoir 22 located in device 10, and in fluid communication with channel 20, is positioned to receive a fluid sample from the second flow region. In an embodiment, reservoir 22 contains means for analyzing and/or identifying specific chemical properties or constituents in the sample. The analytical/identification methods may be passive, active or both. Passive methods include, but are not limited to, the placement of one or more reactive agents in reservoir 22 that chemically react with particular sample constituents. In such embodiments reservoir 22 may be equipped with a window or other visual indicator that is visible at the exterior of device 10. A change of the visual indicator (e.g., color) being indicative of, for example, the presence of certain constituents and/or the level of certain constituents in the sample. Active methods may include the use of analytical detectors that provide local or remote analytical results. In other embodiments reservoir 22 is omitted and the fluid sample is directed only to an external collection receptacle connected to the collection channel outlet 34.

One aspect of the present invention is the placement of the collection channel 20 at the junction 28 of the constriction channel 18 and outlet channel 16. As shown in FIG. 1B, outlet channel 16 has a fluid dispersion entry point 60 located within a transverse face 66 at the outlet channel inlet. The inlet of outlet channel 16 has first and second circumferentially-spaced wall portion, 62 and 64, respectively. The fluid dispersion entry point 60 is located at or near wall portion 62 with the collection channel inlet 26 residing in the second wall portion 64 at a location abutting or nearly abutting transverse face 66. An advantage of this configuration, as will be discussed and illustrated in more detail below, is that it places the inlet 26 of the inlet collection channel 20 within the wide portion, and perhaps widest portion, of the second flow region 52. This provides several advantages. One advantage is that it increases the distance between the collection channel inlet 26 and the first fluid flow region 50, thus minimizing, or eliminating altogether, the migration of particles within the first flow region 50 into collection channel 20. Because the fluid flow characteristics of the fluid dispersion are largely determined by the fluid channel dimensions, placing the collection channel inlet 26 within a wide or widest portion of the second flow region 52 provides a level of design flexibility and accommodates broader manufacturing tolerances, resulting in lower manufacturing costs and higher yields. That is, in accordance with this aspect of the invention, separating device 10 is capable of tolerating greater variations in channel dimensions while maintaining an adequate second flow region width/thickness. The ability to accommodate broader manufacturing tolerances is of particular importance in blood separation devices where the channel dimensions are measured in micrometers. Another advantage is that the separating device 10 is capable of processing more than a single type of fluid dispersion and can accommodate a wider variation in fluid dispersion characteristics. For example, in the case of separating plasma from whole blood, it is typically necessary to reduce the hematocrit of the blood prior to separating the plasma from the blood cells in order to produce a cell-free or essentially cell-free fluid flow at the inlet 26 of collection channel 20. Placing inlet 26 at junction 28 where the plasma flow layer is at its thickest allows blood with a higher hematocrit to be processed with minimized effect on the purity of the plasma collected within channel 20. Moreover, because the temperature and flow rate of the blood being separated effects the thickness of the plasma flow layer, the separating device 10 of the present invention allows for variability in these process parameters with minimized affect on sample purity. This is of particular importance when separating blood since the temperature of the blood source will generally vary by the location of use of the separating device due to different ambient conditions.

In one embodiment the channels of separating device 10 are formed within a substrate 12, as shown in the FIG. 1A. Substrate 12 may comprise silicon, metal, plastic or any other material that is chemically and/or biologically compatible with the fluid dispersion being processed. In microfluidic devices, where the flow channels have very small dimensions, the surface roughness of the substrate material may need to be considered since it may affect fluid flow characteristics. The channels can be formed by any of a variety of known manufacturing methods, such as by lithography, milling, laser cutting, etc. The channel dimensions and/or cross-sectional configuration (e.g. circular, rectangular etc.) will typically vary based upon the type of fluid dispersion being processed, the device operating parameters (e.g., flow, temperature, pressure), the dimensional characteristics of adjoining channels, etc. In some instances one or more dimensional characteristic of one or more of the channels may vary. For example, to produce desired flow and/or pressure profiles within specific regions of the device 10 the channels may be tapered, contain converging and/or diverging segments, etc. In a preferred embodiment the ratio of the cross-sectional areas of the channels are as follows: the ratio of the cross-sectional area of the outlet channel 16 to the constriction channel 18 is between about 10.0 and about 30.0, and preferably between about 15.0 and about 25.0; the ratio of the cross-sectional area of the inlet channel 14 to the constriction channel 18 is between about 5.0 and about 20.0, and preferably between about 10.0 and about 15.0; and the ratio of the cross-sectional area of the outlet channel 16 to the collection channel 20 is between about 5.0 and about 15.0, and preferably between about 8.0 and about 12.0.

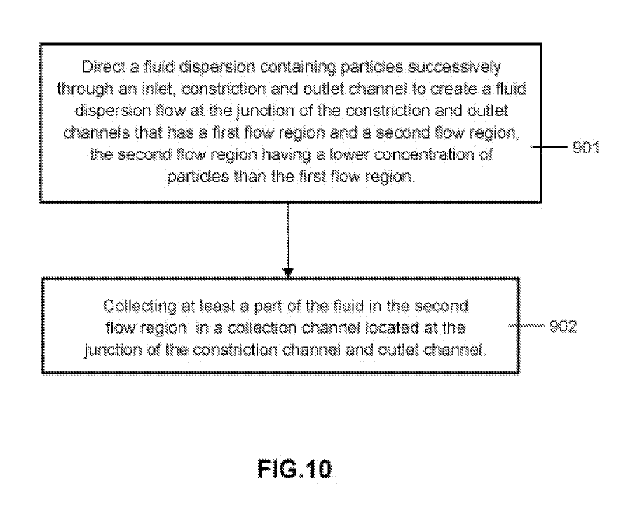

FIG. 10 is a flow chart of a method of separating particles in a fluid dispersion in accordance with the principles described. The method including directing a fluid dispersion containing particles successively through the inlet channel 14, constriction channel 18 and outlet channel 16 of separating device 10 to create a fluid dispersion flow at the junction 28 of the constriction and outlet channels that has a first flow region 50 and a second flow region 52, the second flow region having a lower concentration of particles than the first flow region (block 701). At least a part of the fluid in the second flow region 52 is then collected in channel 20 which is located at the junction 28 of the constriction channel 18 and outlet channel 16 (block 702). In the case of separating blood, a device located upstream inlet channel 14 may be used to reduce the concentration of red blood cells, white blood cells or other constituents within the blood prior to the blood entering the inlet channel.

In a set of experiments for separating plasma from blood the following channel dimensions were used. The inlet channel 14 had a length, width and depth of 1 cm, 400 μm and 40 μm, respectively. The constriction channel 18 had a length, width and depth of 800 μm, 30 μm and 40 μm, respectively. The outlet channel 16 had a length, width and depth of 1 cm, 600 μm and 40 μm, respectively. The collection channel 20 had a length, width and depth of 2.05 cm, 60 μm and 40 μm, respectively. During the experiments the flow behaviour of the blood was observed within the outlet channel 16 in an area at and downstream junction 28 with the use of a microscope and video recorder. The experiments were carried out with different blood flow rates, temperatures and hematocrit values. It is important to note that although the experiments were performed using the channel dimensions recited above, the invention is in no way limited to these dimensions. Further, it is appreciated that the device dimensions may vary widely from one application to another.

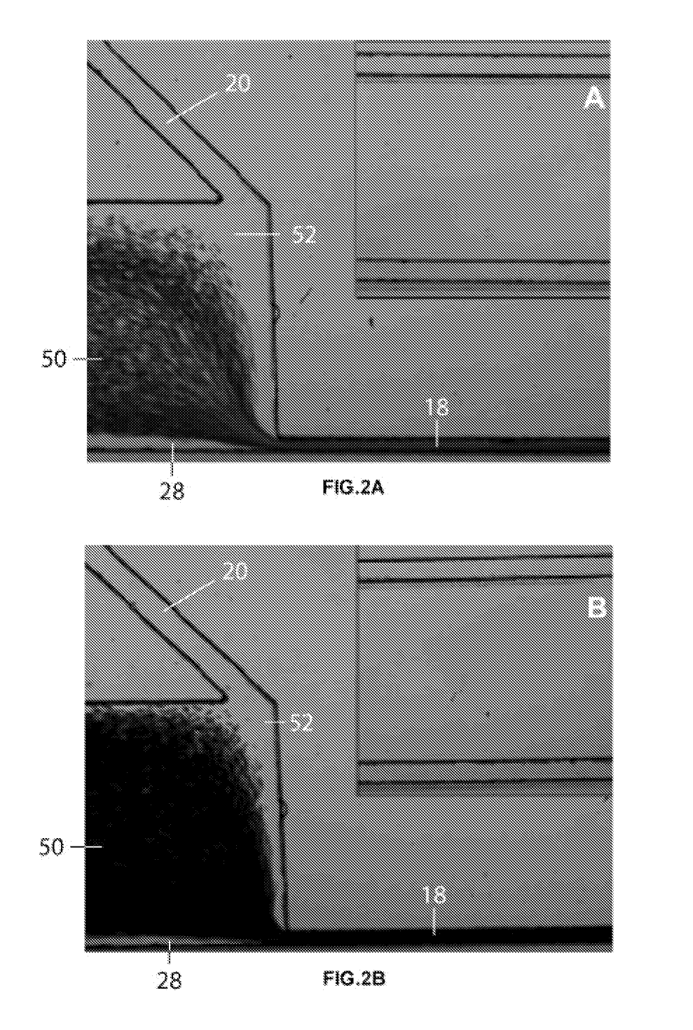

FIGS. 2A and 2B are photographs showing the formation of the first and second fluid dispersion flow regions, 50 and 52, respectively, at the junction 28 of the constriction channel 18 and outlet channel 16. In FIG. 2A a blood sample having a hematocrit of 20% was processed at a flow rate of 504/min and at a temperature of 26° C. In FIG. 2B, a blood sample having a hematocrit of 30% was processed at the same flow rate and temperature. As discussed above, flow regions 50 and 52 are induced by a combination of the Fahraeus effect and the Zweifach-Fung effect. Flow region 50 representing a flow stream having a higher concentration of blood cells. Flow region 52 representing the plasma flow stream created as a result of the blood cells migrating away from the channel wall and moving to the higher flow rate flow path. As shown in the photographs, a reduction in the hematocrit of the blood being processed created a thicker/wider plasma flow stream at junction 28.

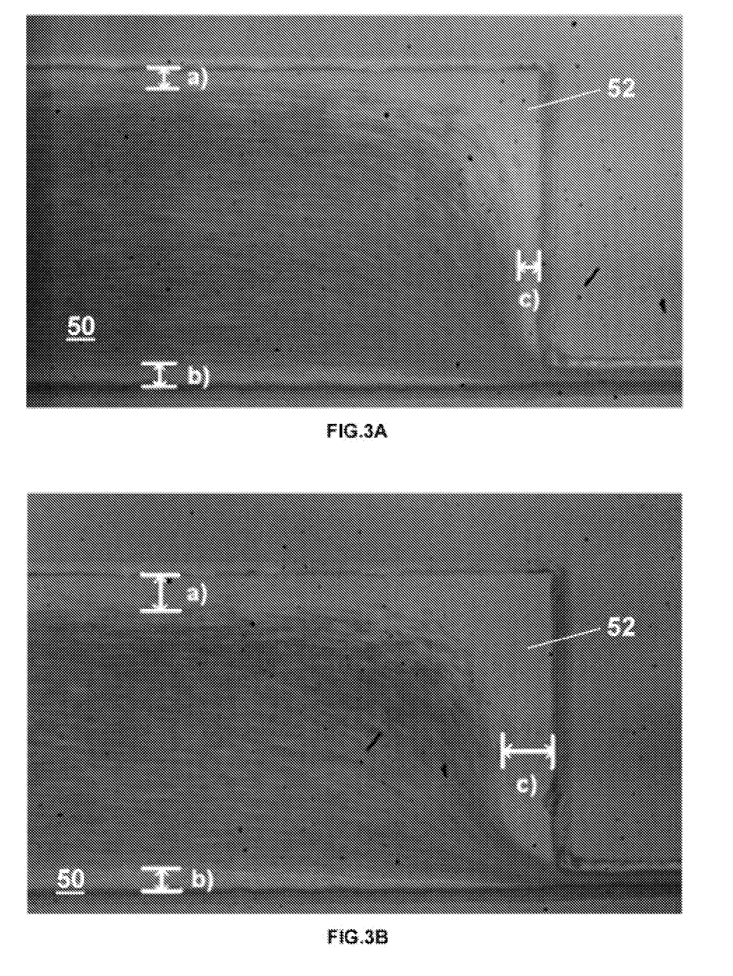

FIGS. 3A and 3B are photographs of a similar junction showing the effect of varying the temperature of the processed blood. In both experiments blood at a flow rate of 704/min and a hematocrit of 20% were used. In the experiment of FIG. 3A the blood was processed at a temperature of 25° C. In the experiment of FIG. 3B the blood was processed at a temperature of 50° C. As clearly shown by the photographs, there was a significant increase in the thickness of the plasma flow stream 52 at the junction at the higher temperature as illustrated by dimension “c”. In addition, the thickness and purity of the plasma flow stream was sustained for a greater distance as illustrated by dimension “a”. There was little change in the lower plasma flow stream as illustrated by dimension “b”. As will be discussed in more detail below, an advantage of having a sustained plasma flow stream is that it permits the use of a greater number of collection channels, thus enhancing the collection performance of the separating device.

FIG. 5 shows a graph of experimental data that shows the plasma flow stream thickness as a function of the blood temperature. The data was obtained using 20% hematocrit blood at a flow rate of 70 μL/min. Dimensions “a”, “b” and “c” are taken at the same locations as those shown in the photographs of FIGS. 3A and 3B. As seen, the thickness of the plasma flow stream at the junction of the constriction and outlet channels (dimension “c”) increases as the temperature of the blood increases. Notably, the thickness “c” increasing by about 250% as the temperature of the blood is raised from 23° C. to 45° C., and by about 275% when the temperature is raised to 50° C. The thickness “a” of the plasma stream is also shown to increase as the operating temperature of the device is increased, the thickness “a” increasing by about 50% as the temperature of the blood is raised from 23° C. to 45° C.

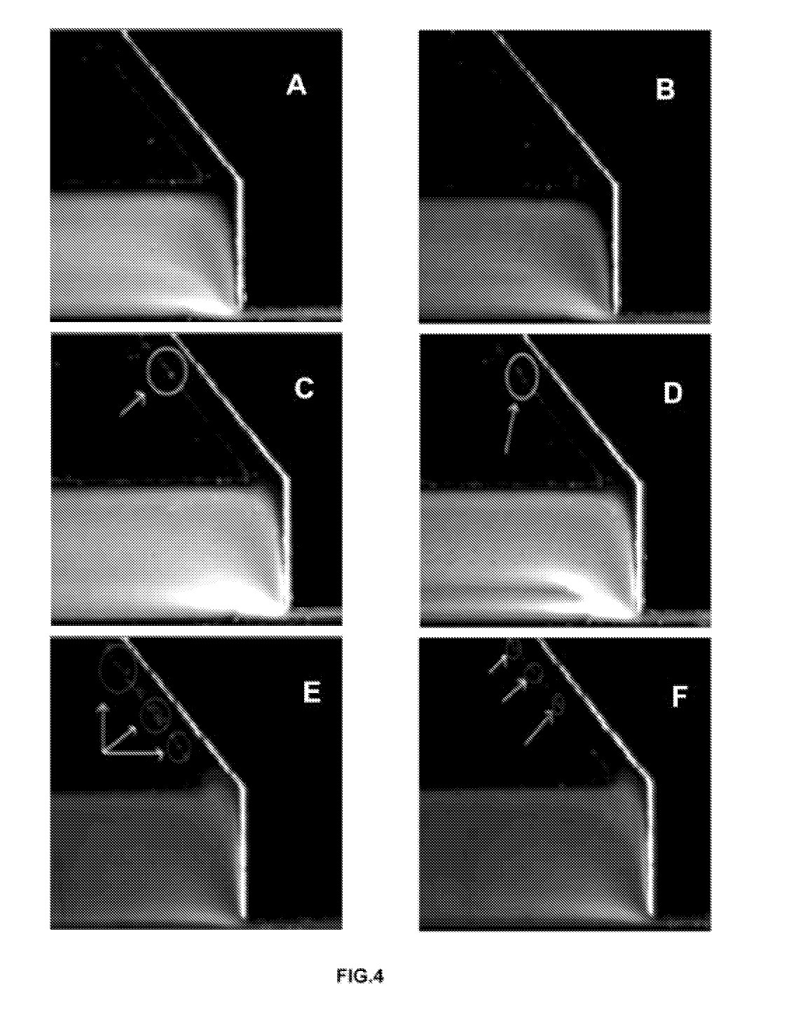

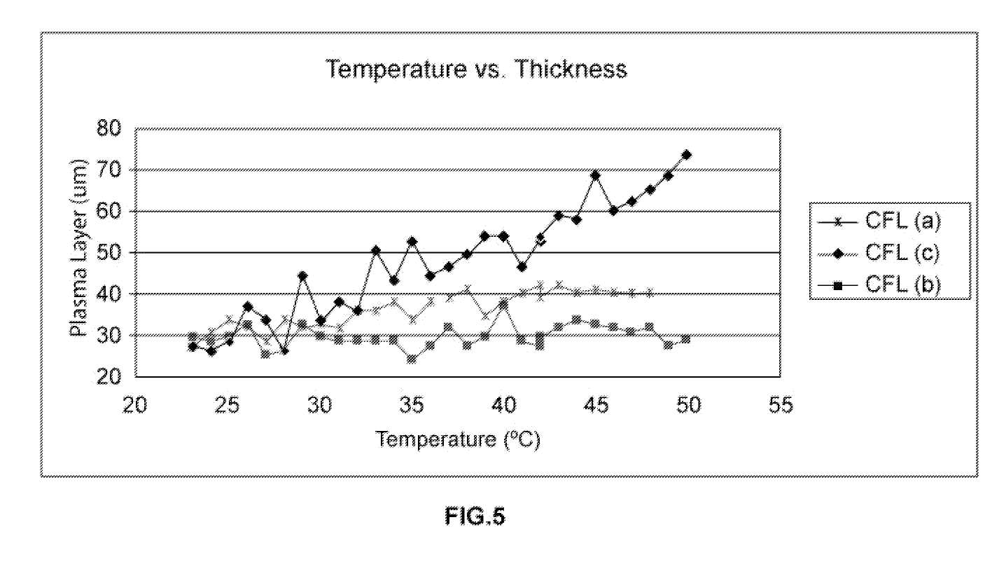

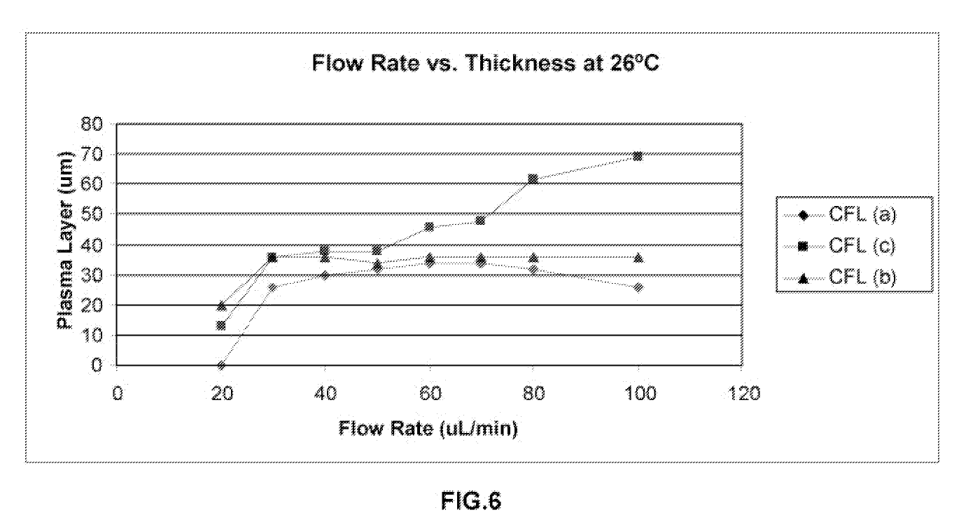

FIG. 4 shows a variety of photographs labelled “A”, “B”, “C”, “D”, “E” and “F”, each showing a blood flow stream profile at the junction 28 of the constriction channel 18 and outlet channel 16 under different experimental conditions. In each of the experiments the blood flow rates were varied between 54/min and 50 μL/min, the figures themselves representing flow rates of 50 μL/min. In photographs “A” and “B” blood having a 20% hematocrit was processed at a temperature of 26° C. and 37° C., respectively. In photographs “C” and “D” blood having a 30% hematocrit was processed at a temperature of 26° C. and 37° C., respectively. In photographs “E” and “F” whole blood was processed at a temperature of 26° C. and 37° C., respectively. At concentrations of up to 20% hematocrits the device efficiently separated plasma from the blood cells at flow rates between 5 μL/min and 50 μL/min. The efficiency of the separation of the blood cells and blood plasma was dependent on the interaction between the percent hematocrits and flow rate. At hematocrit concentrations above 20% some cells escaped into the collection channel 20 as indicated by the arrows. As shown in the photographs, the thickness of the plasma flow stream at junction 28 was greater at the 37° C. operating temperature as compared to the 26° C. operating temperature.

The data obtained in the experiments of FIGS. 3 through 5 shows that by increasing the temperature of the processed blood above ambient temperature a thicker plasma flow stream layer is produced at the outlet of the constriction channel 18. Moreover, the data shows that the thickness and purity of the plasma flow stream is sustained for a greater distance in the outlet channel downstream the constriction channel outlet. In an embodiment of the present invention the temperature of the fluid dispersion is elevated above ambient temperature prior to separation. In the case of processing blood, the blood is preferably processed at a temperature between about 30° C. and about 50° C., and more preferably between about 35° C. and about 45° C. As shown in FIG. 1A, one or more resistors 90 that are connected to an internal or external power source may be embedded in substrate 12 to elevate or otherwise control the temperature of the fluid dispersion. Temperature sensors located within the device channels or substrate may be used monitoring the temperature and/or controlling the power delivered to resistors 90. In other embodiments, device 10 may be thermally coupled to a separate thermal plate or to an integrated thermal plate having a local or remote power source.

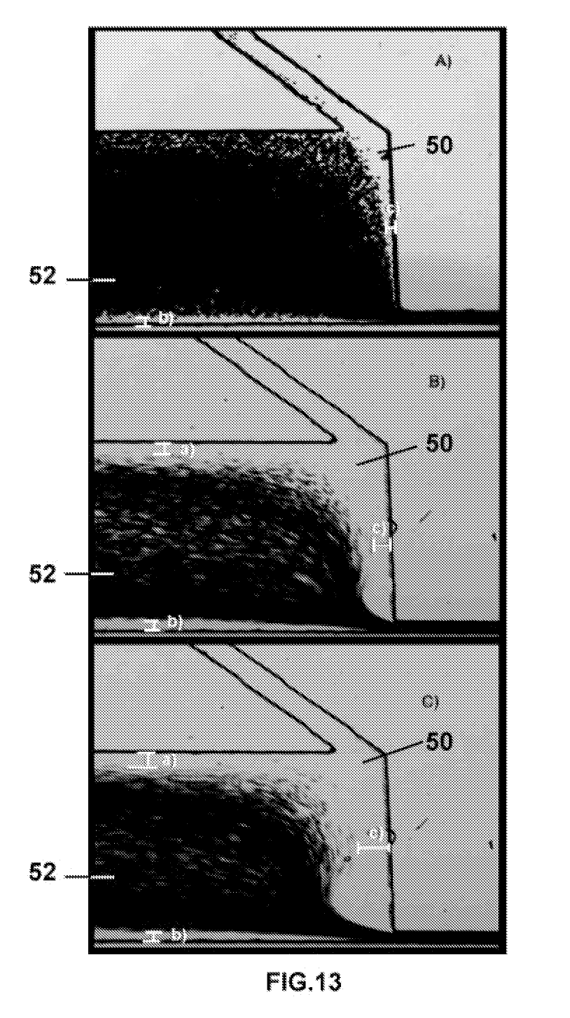

FIG. 6 shows a graph of experimental data that shows the plasma flow stream thickness as a function of the flow rate. The data was obtained using 20% hematocrit at a blood temperature of 26° C. Dimensions “a”, “b” and “c” are taken at the same locations as those shown in the photographs of FIGS. 3A and 3B. As seen the thickness of the plasma flow stream at junction 28 (dimension “c”) increases as the blood flow rate through the device increases. The thickness “c” increasing by about 200% as the flow rate of the blood increases from 30 μL/min to 100 μL/min. Additional experimentation showed that the device effectively separated plasma from blood at flow rates up to about 190 μL/min. Processing blood at relatively high flow rates (flow rates greater than about 5 μL/min, and preferably greater than about 30 μL/min) provide several advantages. As the data shows, thicker plasma flow layers are achieved at the outlet of the constriction 18. The higher flow rates also allow a larger volume of the fluid dispersion to be processed per unit time which means that (1) sample volumes may be processed more rapidly, and (2) larger volumes of blood may be processed. The ability to separate and analyze larger fluid dispersion volumes is advantageous because the analytical results derived from the large volumes are typically more representative of the fluid dispersion at its point of origin. In the case of processing biological fluid dispersions, separating devices that use flow rates that more closely mimic biological flow rates can be advantageous. In addition, these devices are more adaptable to in-vivo applications. Photographs A, B and C of FIG. 13 show the flow behaviour of the blood at flow rates of 20 μL/min, 60 μL/min and 100 μL/min, respectively.

With reference to FIGS. 1C through 1F, alternative embodiments of separating device 10 are shown. In FIG. 1C the collection channel 20 is shown having a meandering or serpentine shape. Proper operation of separating device 10 relies in part on maintaining a back pressure in collection channel 20. The back pressure must be properly controlled so as to maintain an appropriate pressure profile in the outlet channel 16 near the collection channel inlet 26. Insufficient back pressure can result in a low pressure zone at the collection channel inlet 26 that permits blood cells within the first flow region 50 to migrate toward and into the collection channel inlet 26. Adjusting the length of the collection channel is one way of controlling the back pressure in collection channel 20. The use of a meandering or serpentine shaped collection channel permits the use of longer collection channels without compromising the small-scale dimensions of the device 10.

In the separating device of FIG. 1A the inlet segment 23 of collection channel 20 is positioned at a 45 degree angle as measured in a clock-wise direction from the longitudinal axis 100 of outlet channel 16. The invention, however, is not limited to this configuration or to any particular angular position of the collection channel. However, it has been shown that varying the angular orientation of the collection channel 20 with respect to the longitudinal axis 100 of outlet channel 16 affects the fluid flow velocity at the collection channel inlet 26 and that this angle can be adjusted to optimize collection efficiency and/or the purity of the sample collected. It has also been shown that the optimum angular positions of the collection channel reside between about 45 degrees and about 135 degrees as measured in a clock-wise direction from axis 100. For this reason, alternative preferred embodiments of the invention utilize collection channels having angular orientations between about 45 degrees and about 135 degrees. In the embodiment of FIG. 1D, the collection channel 20 is shown at an angle of 135 degrees.

In each of the fluid dispersion separating devices described herein, the collection channels may be equipped with constrictions at their inlets and/or contain a reduced diameter section within their inlet segments to assist in controlling the pressure and flow profile of the fluid dispersion in a manner to inhibit the migration of unwanted particles into the collection channels.

FIG. 1E illustrates an embodiment having a plurality of collection channels 20a, 20b and 20c located within outlet channel 16. Channel 20a is positioned similar to channel 20 shown in FIG. 1A with channels 20b and 20c positioned at successive downstream locations from channel 20a. Although three collection channels are shown, it is appreciated that fewer or more than three collection channels may be used. An advantage of using multiple collection channels is that it increases the sample collection rate of the separating device. In embodiments where the thickness and purity of the plasma flow stream is sustained at greater distances from the outlet of the constriction 18, as discussed above, a greater number of collection channels may be used to increase the plasma flow collection rate.

In some instances it may be desirable to collect and analyze a sample from the first flow region 50 containing a concentration of blood cells. In the embodiment of FIG. 1F, a collection channel 70 having an inlet 76 within outlet channel 16 is provided for such a purpose. Similar to collection channel 20, collection channel 70 is connected to a reservoir 72 located within the device substrate 12. In an embodiment, reservoir 72 contains means for analyzing and/or identifying specific chemical properties or constituents in the sample. The analytical/identification methods may be passive, active or both. Passive methods include, but are not limited to, the placement of one or more reactive agents in reservoir 72 that chemically react with particular sample constituents. In such embodiments reservoir 72 may be equipped with a window or other visual indicator that is visible at the exterior of device 10. A change of the visual indicator (e.g., color) being indicative of, for example, the presence of certain constituents and/or the level of certain constituents in the sample. Active methods may include the use of analytical detectors that provide local or remote analytical results. In other embodiments reservoir 72 is omitted and the fluid sample is directed only to an external collection receptacle connected to the collection channel outlet 74.

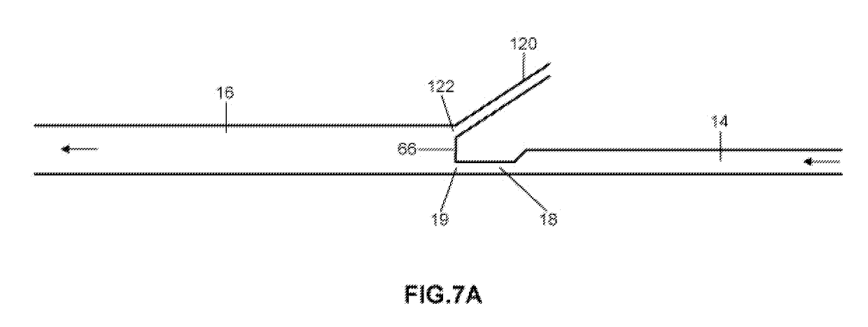

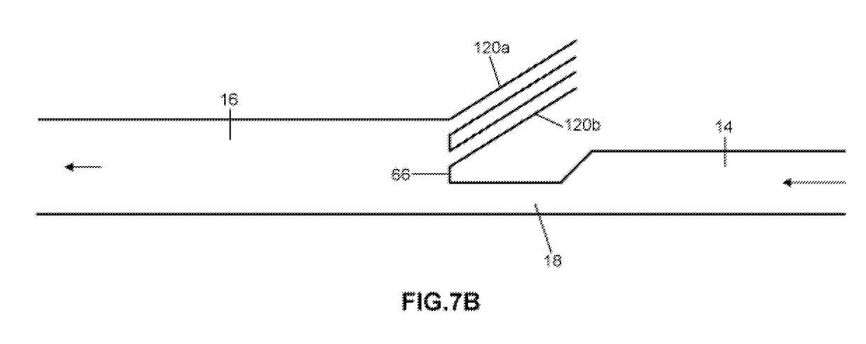

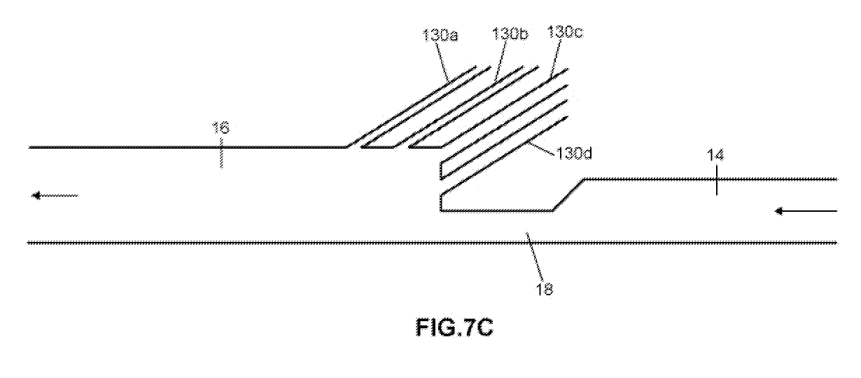

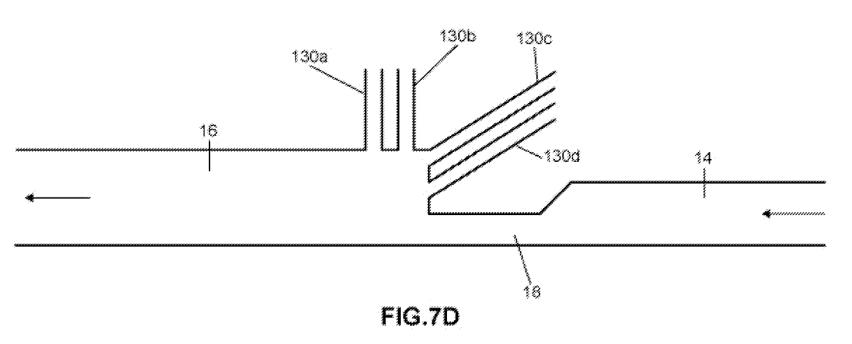

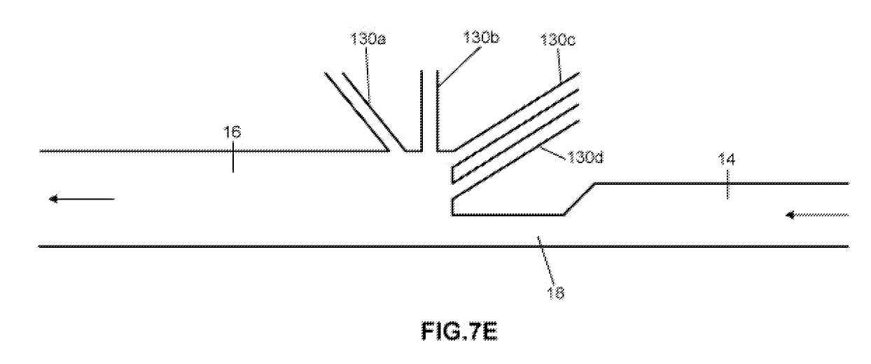

Referring back to the photographs in FIGS. 2 through 4 it is seen that the plasma flow stream 52 flows along the transverse face 66 of the outlet channel inlet, and more significantly, that the thickness of the plasma flow stream can be at its widest at locations along the transverse face. Hence, in alternative embodiments one or more collection channels are placed within transverse wall 66 as shown in FIGS. 7A through 7E. In FIG. 7A a single collection channel 120 is placed within the transverse wall 66 with its inlet 122 positioned at a location farthest away from the constriction channel outlet 19. In other embodiments the inlet 122 of collection channel 120 is positioned at other locations along transverse wall 66.

FIG. 7B shows an embodiment where a plurality of collection channels 120a and 120b are positioned within transverse face 66. As previously discussed, an advantage of using multiple collection channels is that it increases the collection rate of the sample being retrieved. To maximize the collection rate, it may be desirable to place collection channels in both the transverse wall 66 and the side wall portion 64 of outlet channel 16 since the plasma flow stream can have a significant thickness in both locations. The embodiment of FIG. 7C takes advantage of this by using multiple collection channels 130a-d, some of which are placed in the wall portion 64 of outlet channel 16 (channels 130a and 130b), with others placed in transverse wall 66 (channels 130c and 130d).

As described above, the angular orientation of the collection channels may be varied to optimize collection efficiency and/or the purity of the sample collected. FIGS. 7D and 7E illustrate alternative embodiments of the invention wherein the collection channels 130a-d have different angular orientations.

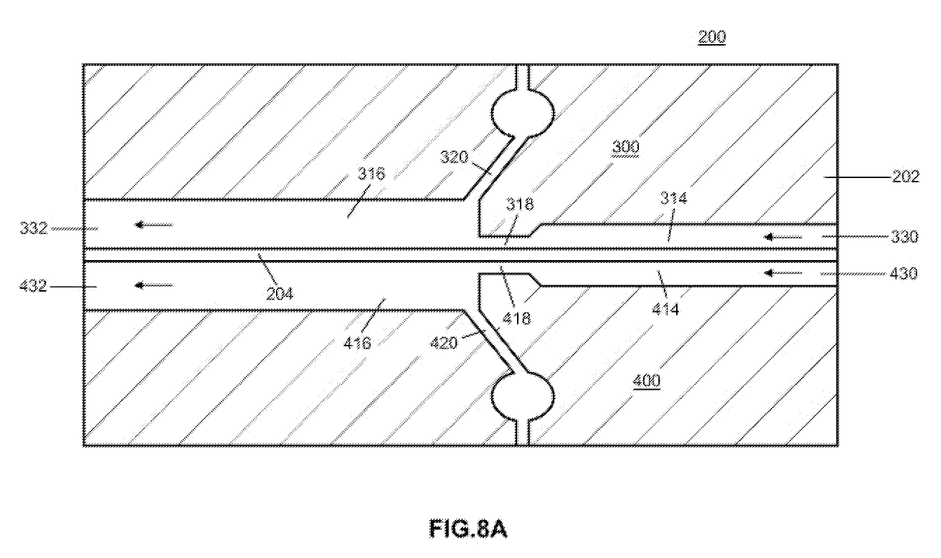

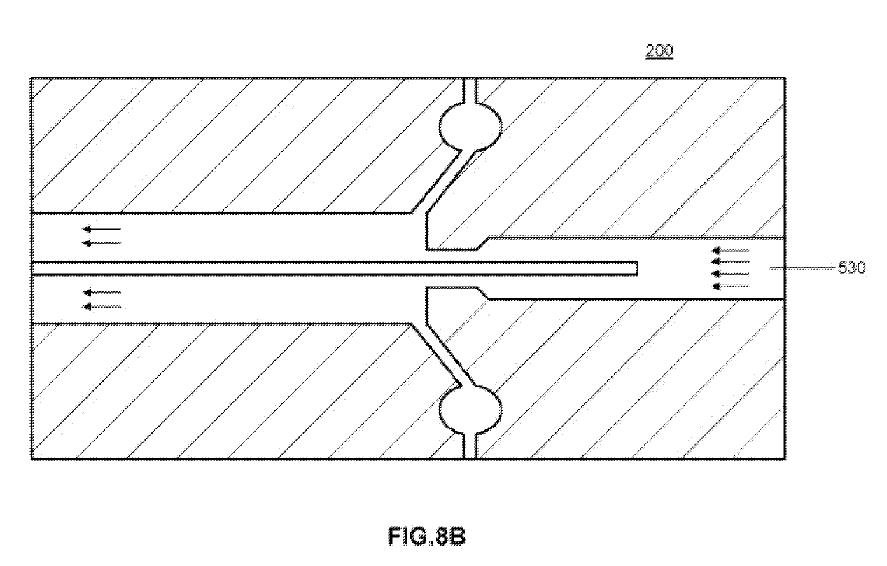

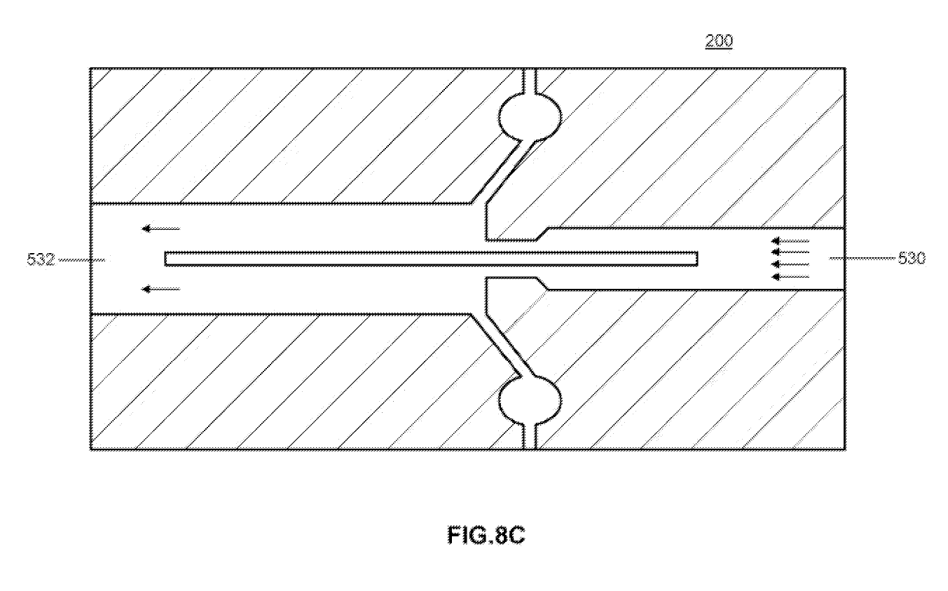

FIGS. 8A-8C depict alternative embodiments of fluid dispersion separating devices 200 wherein multiple separating units 300 and 400 are formed within a single substrate 202. In the embodiment of FIG. 8A separating unit 300 includes an inlet channel 314, a constriction channel 318, an outlet channel 316 and a collection channel 320 formed within a first portion of substrate 202. Separating unit 400 also includes an inlet channel 414, a constriction channel 418, an outlet channel 416 and a collection channel 420 and is formed within a second portion of substrate 202. The two separating units are separated by a wall 204 with each having their own inlet (330 and 430) and outlet (332 and 432). In the embodiment of FIG. 8B, the separating units 300 and 400 share a common inlet 530. In the embodiment of FIG. 8C, the separating units share both a common inlet 530 and a common outlet 532. Note that the various features associated with the embodiments described in FIGS. 1A-1F and FIGS. 7A-7E above may be incorporated into one or both of separating units 300 and 400. Additionally, it is to be appreciated that the separating device 200 may have greater than two separating units and that the separating units need not have the same structure or dimensional characteristics. In separating units having very small dimensional characteristics, photo-lithography methods may be used to produce tens and even hundreds of separating units within a single substrate. A number of benefits are derived by the use of multiple separating units in a single device. One benefit is that it enables larger sample volumes to be collected and in less time. Another benefit is that it permits multiple sets of analyses to be carried out on a single fluid dispersion or on multiple fluid dispersions within a single device.

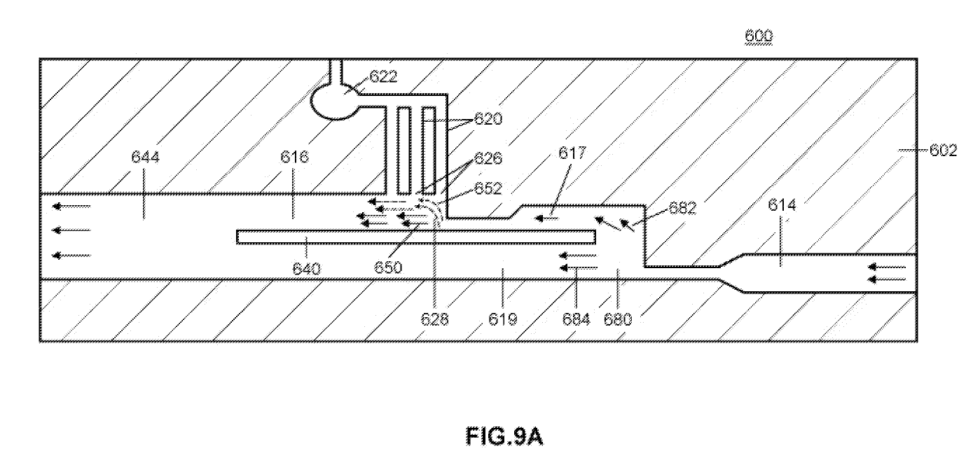

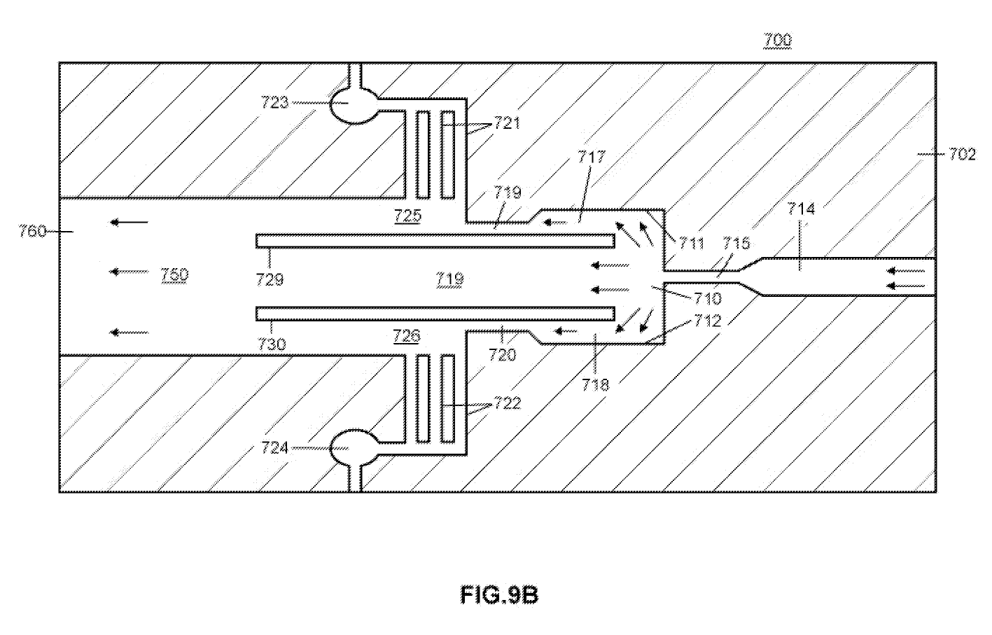

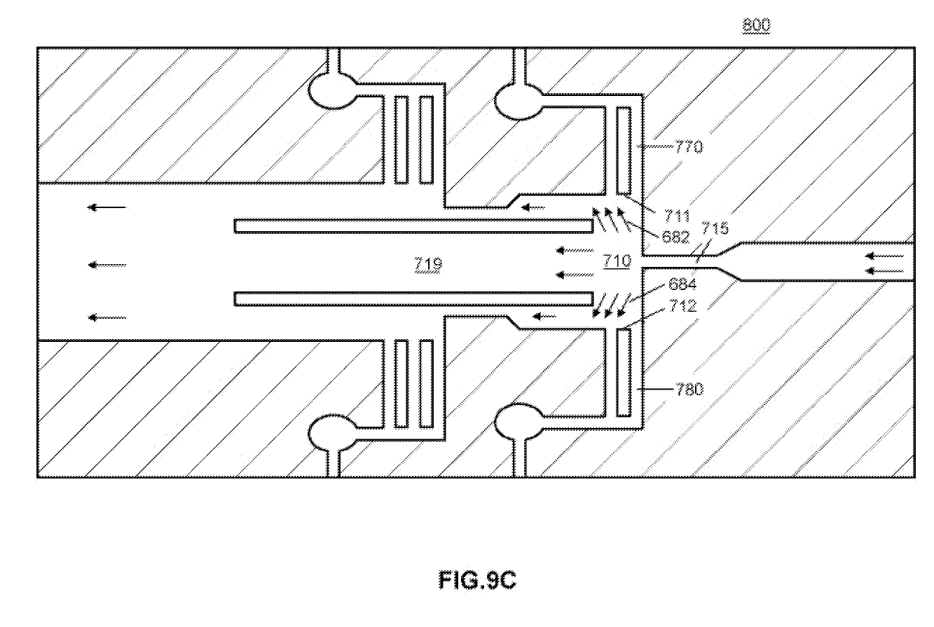

Looking now at FIG. 9A what is shown is fluid dispersion separating device 600 having a first set of structures for creating a diluted fluid dispersion flow and a second set of structures for separating the diluted fluid dispersion for sample collection purposes. Device 600 has an inlet channel 614 and a flow separation channel 680 that are adjoined by a first constriction 615. The first constriction and flow separating channels are configured to create within the inlet of the separation channel 680 a dispersion fluid flow having a first dilute flow region 682 and a first concentrate flow region 684. The diluted fluid dispersion flowing into a dilute channel 617 with the concentrated fluid dispersion taking the path of a concentrate channel 19 that is separated from the dilute channel 617 by wall segment 640. Device 600 further includes a second constriction 618 that adjoins the dilute channel 617 to an outlet channel 616. The channels are configured to create at the junction 628 of the second constriction channel 618 and the outlet channel 616 a fluid dispersion flow having a second dilute flow region 652 and a second concentrate flow region 650. One or more collection channels 620 having inlets 626 located within the second dilute flow region 652 are configured to receive at least a portion of the fluid in the second dilute flow region 652. A reservoir 622 in fluid communication with collection channels 620 may be incorporated into the substrate 602 in the same manner and for the same purpose of reservoir 22 in the embodiments described above.

The fluid dispersion separating device 600 offers many advantages. First, it enhances the purity of the sample collected by pre-diluting the fluid dispersion prior to separating it for sample collection purposes. And because pre-dilution enables the creation of thicker and longer second dilute flow regions, it enables the use of a larger number of collection channels 620 which, in turn, enhances the collection efficiency of the device. Another important advantage offered by device 600 is that it can reduce or eliminate altogether the need of pre-processing a fluid dispersion prior to being introduced into the device. As discussed above, in order to obtain cell-free or essentially cell-free plasma from blood, existing plasma separating devices require that the blood hematocrit be reduced prior to being introduced into the devices. These processes can be costly and time consuming. Using the pre-dilution methods described herein, whole blood taken directly from a patient may be effectively separated to obtain a cell-free or essentially cell-free plasma sample without the need of reducing the blood hematocrit prior to the blood being introduced into the separating device.

In the embodiment of FIG. 9A structures are provided for pre-diluting the fluid dispersion once prior to be separated for sample collection purposes. It is important to note that the present invention is not limited to one set of pre-dilution structures, but may include a plurality of serially positioned dilution structures where the fluid dispersion is incrementally diluted prior to being separated for sample collection purposes. Moreover, the present invention is not limited to embodiments where the pre-dilution structures and/or devices are provided within the same substrate or platform as the separating structure/devices used for separating the fluid dispersion for sample collection purposes. For example, in one embodiment the inlet channel 614, first constriction channel 615, separation channel 680 and dilute channel 617 are incorporated into a separate dilution device and connected to the inlet 30 of separating device 10 depicted in FIG. 1A. In such an embodiment the outlet of dilute channel 617 within the dilution device is connected to the inlet channel 14 of device 10. The dilution device may include a plurality of serially positioned dilution structures where the fluid dispersion is incrementally diluted prior to being separated for sample collection purposes. The number of serial dilution structures used will vary from one application to another and will depend largely on the desired purity level of the sample to be analyzed.

In addition, more than one separating unit may be provided within a single device substrate to produce the same benefits described in conjunction with the embodiments of FIG. 8A-8C. One method of providing multiple separating units is to reproduce the fluid dispersion separating structure of FIG. 9A multiple times within a single substrate. It is important to note that the separating devices within a single substrate need not be identical and may vary widely in form. FIG. 9B represents one of many possible embodiments. As shown, separating device 700 has an inlet channel 714 and a separation channel 710 that are adjoined by a first constriction 715. Dilute channels 717 and 718 are provided at the exit on opposing sides of the separation chamber 710 and are separated from a common concentrate channel 719 by wall segments 729 and 730, respectively. On one side a constriction channel 719 connects dilute channel 717 to a first outlet channel 725 having one or more collection channels 721 located therein. On the other side a constriction channel 720 connects dilute channel 718 to a second outlet channel 726 which likewise has one or more collection channels 722. Collection reservoirs 723 and 724 are optionally provided for purposes similar to those discussed in previous embodiments. In the embodiment of FIG. 9B, concentrate channel 719 and first and second outlet channels 725 and 726 meet at a device outlet channel 750. In alternative embodiments, one or both of wall segments 729 and 730 may be extended to the device outlet 760 to create separate outlets. Note that the various features associated with the embodiments described in FIGS. 1A-1F and FIGS. 7A-7E above may be incorporated into the alternative embodiments of FIGS. 9A and 9b, and also into the embodiment of 9C described below.

FIG. 9C illustrates a fluid dispersion separation device 800 similar to the device 700 of FIG. 9B, with the exception that collection channels 770 and 780 are provided within opposing walls 711 and 712 of separation channel 710 to permit samples from the first diluted flow streams 682 and 684 to be collected and analyzed.

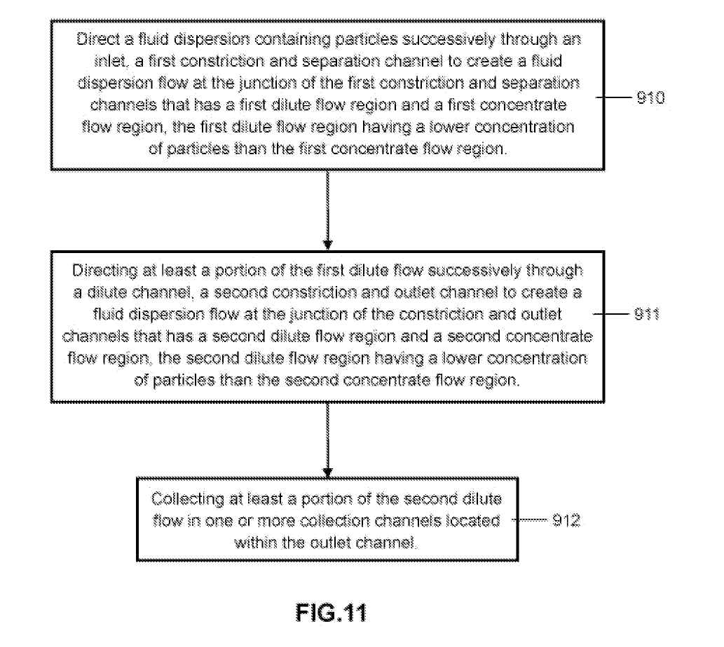

FIG. 11 is a flow chart of a method of separating particles in a fluid dispersion in accordance with the principles just described. The method including directing a fluid dispersion containing particles successively through an inlet, a first constriction and separation channel to create a fluid dispersion flow at the junction of the constriction and separation channels that has a first dilute flow region and a first concentrate flow region (block 910). A portion of the first dilute flow is then directed successively through a dilute channel, a second constriction and outlet channel to create a fluid dispersion flow at the junction of the second constriction and outlet channels that has a second dilute flow region and a second concentrate flow region (block 911). At least a portion of the second dilute flow is then collected in one or more collection channels located in the outlet channel (block 912).

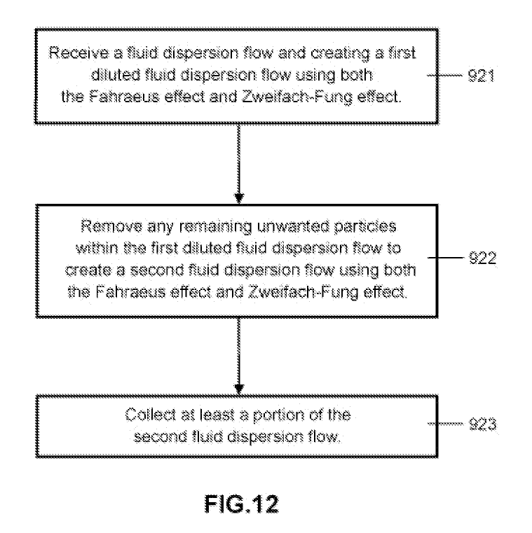

FIG. 12 is another flow chart of a method of separating particles in a fluid dispersion in accordance with certain aspects of the present invention. The method including receiving a fluid dispersion flow and creating a first diluted fluid dispersion flow using both the Fahraeus effect and Zweifach-Fung effect (block 920) and subsequently removing any remaining unwanted particles within the first diluted fluid dispersion flow to create a second fluid dispersion flow using again both the Fahraeus and Zweifach-Fung effect (block 921) and, finally, collecting at least a portion of the second fluid dispersion flow.

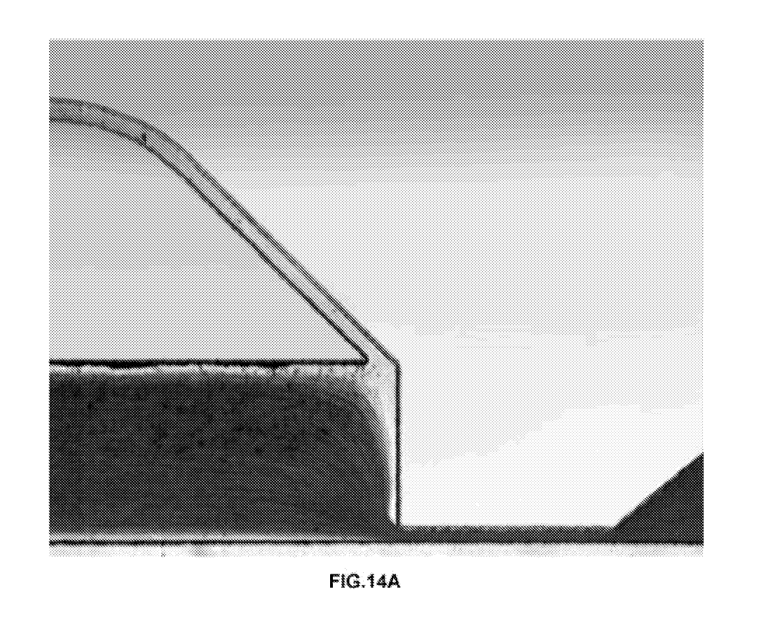

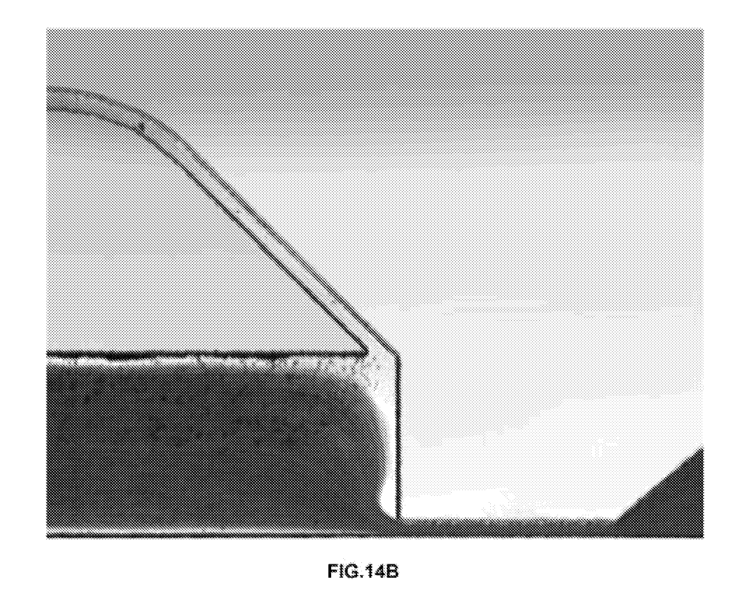

FIGS. 14A and 14B show photographs of the flow in an outlet and collection channel in experiments carried out using a separating device according to the present invention. In this embodiment, the device for separating particles in a fluid dispersion comprised a configuration with a single separating unit and a single constriction. The channels of the separating device were formed within a PDMS (Polydimethylsiloxane) substrate and had the following dimensions. The inlet channel had a length of 1.0 cm, a width of 400 μm and a depth of 30 μm. The constriction channel had a length of 800 μm, a width of 30 μm and a depth of 30 μm. The outlet channel had a length of 1.0 cm, a width of 600 μm and a depth of 30 μm. The collection channel had a length of 4.4 cm, a width of 60 μm and a depth of 30 μm. In these experiments, the separating device was used to separate plasma from blood having 30% hematocrit. The experiments were carried out at room temperature and the blood was manually injected into the device using a syringe. The flow rate was variable between approximately 150 μl/min and approximately 250 μl/min. The flow rate may also momentarily have been as high as 300 μl/min or 450 μl/min. During the experiments the flow behaviour of the blood was observed within the outlet channel in an area at the junction with the constriction channel and downstream of said junction using a microscope and a video recorder recording at 2000 frames per second. (In general, the frames per second of the video may be varied e.g. between 125 fps and 3000 fps. With higher flow rates, higher frames per second are needed to observe the flow.) In the video recording, it was observed that a plasma 100% free of red blood cells was obtained in the collection channel. FIGS. 14A and 14B show two frames (photographs) of this video recording. Although the photographs show some black dots and spots in the collection channel, these are merely due to some impurities or imperfections in the HPMS substrate (such as dust particles that were stuck to the substrate). The difference between the two photographs of FIGS. 14A and 14B is the instantaneous flow rate. The instantaneous flow rate in FIG. 14B is higher and a vortex that is created at the outlet of the constriction channel can be seen in this figure. As shown, even with the presence of a vortex, plasma 100% free of red blood cells was obtained in the collection channel.

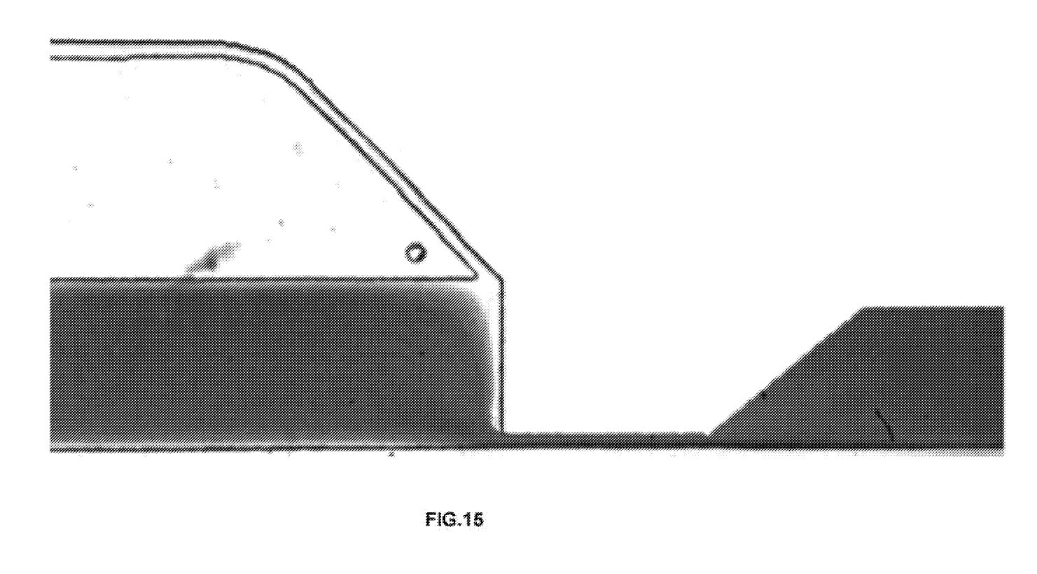

FIG. 15 illustrates by way of a photograph the flow conditions in an outlet and collection channel in experiments for separating plasma from whole blood with another separating device according to the invention. In these experiments, it was found that even using whole blood from humans (with hematocrit between approx. 37% and 54%), plasma 100% free of red blood cells may be obtained using a device or method according to the present invention. In these experiments, the device for separating particles in a fluid dispersion comprised a configuration with a single separating unit and a single constriction. The channels of the separating device were formed within a PDMS substrate and had the following dimensions. The inlet channel had a length of 0.9 cm, a width of 400 μm and a depth of 30 μm. The constriction channel had a length of 800 μm, a width of 30 μm and a depth of 30 μm. The outlet channel had a length of 0.9 cm, a width of 600 μm and a depth of 30 μm. The collection channel had a length of 10.0 cm, a width of 60 μm and a depth of 30 μm. The experiments were carried out at room temperature and the blood was manually injected into the device using a syringe. The flow rate was variable between approximately 150 μl/min and approximately 250 μl/min. The flow rate may also momentarily have been as high as 300 μl/min or 450 μl/min. Using a microscope and high speed camera, recording at 2000 frames per second, the flow behaviour of the blood was observed within the outlet channel in an area at the junction with the constriction channel and downstream of said junction. In the video recording it was observed that plasma, which was 100% free of red blood cells, was obtained in the collection channel.

It was thus observed that with a separating device according to the present invention, plasma 100% free of red blood cells may be obtained even when using whole blood from humans. This is a great advantage offered by the present invention, since it is not necessary to pre-process the blood in any way before injecting it into the separating device in order to obtain plasma free from red blood cells.

Although it was only shown here for one separating device, same results (plasma 100% free of red blood cells) may be obtainable using separating devices according to the present invention with channels of different dimensions.

In some aspects, the methods and devices of the invention can render “plasma substantially free of red blood cells” or “liquid substantially free of particulars” by reducing the amount of red blood cells (or specific particles of interest). In preferred embodiments, the reduction of red blood cell concentration (or other specific particle) is more than 10%, 25%, 50%, 75%, 90%, 95%, or 99%. Preferably, the amount of particles that are removed from the liquid dispersion by the inventive method and device is sufficient as to not interfere with obtaining reliable results in a clinical chemistry test on the resulting sample.

In some embodiments, it is desired that a small concentration of specific cells (or particles) are collected in the collection channel so that these cells can be specifically detected. For example, the collection channel may be configured to entrain a specific amount of cells, on a real time continuous basis for detecting e.g., circulating tumor cells, or other cells that may be indicative of a specific medical condition.

In some embodiments of the invention, the width of the constriction channel is less than 100 μm. In some embodiments of the invention, the width of the constriction channel is less than 80 μm. In some embodiments of the invention, the width of the constriction channel is less than 60 μm. In some embodiments of the invention, the width of the constriction channel is less than 50 μm. In some embodiments of the invention, the width of the constriction channel is less than 40 μm.

In some embodiments of the invention, the length of the constriction channel is less than 1200 μm. In some embodiments of the invention, the length of the constriction channel is less than 1100 μm. In some embodiments of the invention, the length of the constriction channel is less than 1000 μm. In some embodiments of the invention, the length of the constriction channel is less than 950 μm. In some embodiments of the invention, the length of the constriction channel is less than 900 μm.

In some embodiments of the invention, the length of the constriction channel is greater than 200 μm. In some embodiments of the invention, the length of the constriction channel is greater than 300 μm. In some embodiments of the invention, the length of the constriction channel is greater than 400 μm. In some embodiments of the invention, the length of the constriction channel is greater than 500 μm. In some embodiments of the invention, the length of the constriction channel is greater than 600 μm.

In some embodiments of the invention, the depth of the constriction channel is less than 100 μm. In some embodiments of the invention, the depth of the constriction channel is less than 80 μm. In some embodiments of the invention, the depth of the constriction channel is less than 60 μm. In some embodiments of the invention, the depth of the constriction channel is less than 50 μm. In some embodiments of the invention, the depth of the constriction channel is less than 45 μm.

In some embodiments of the invention, the depth of the constriction channel is more than 5 μm. In some embodiments of the invention, the depth of the constriction channel is more than 10 μm. In some embodiments of the invention, the depth of the constriction channel is more than 15 μm. In some embodiments of the invention, the depth of the constriction channel is more than 20 μm. In some embodiments of the invention, the depth of the constriction channel is more than 25 μm.

For separating plasma from blood, it has been found that separating devices according to the present invention with the following preferred dimensions give good results (plasma with a significant reduction of red blood cells). The inlet channel may have length, width and depth, between 400 μm-4 cm, 100-800 μm and 20-60 μm respectively. The constriction channel may have length, width and depth between 500-900 μm, 20-35 μm and 20-60 μm respectively. The outlet channel may have length, width and depth between 6 mm-2.5 cm, 350-750 μm, and 20-60 μm respectively. The collection channel may have length, width and depth between 4.5-13 cm, 57-65 μm and 20-60 μm respectively. For separating plasma from blood with higher hematocrit levels (such as whole blood), it has been found that separating devices according to the present invention with the following preferred dimensions give best results (plasma with a significant reduction of red blood cells). The inlet channel may have length, width and depth between 600 μm-1 cm, 300-600 μm and 25-35 μm respectively. The constriction channel may have length, width and depth between 600-800 μm, 25-35 μm and 25-35 μm respectively. The outlet channel may have length, width and depth between 9 mm-1 cm, 500-650 μm and 25-35 μm respectively. The collection channel may have length, width and depth between 7.5-10 cm, 58-62 μm and 25-35 μm respectively. In this respect it is worth noting that the length and width of the inlet channel may be varied widely without significantly influencing the results. As was already explained, the dimensions of the collection channel should be chosen such as to create appropriate back pressure in the collection channel. It has been found that advantageous pressure ratios between outlet channel and collection channel may vary between 3 and 6 (but the pressure ratio may be varied even more depending on other working conditions, such as flow rate, temperature etc.). It has further been found that for separating plasma from blood in separating devices with such dimensions, it is advantageous to use a flow rate of about 100 μl/min or greater and preferably of about 150 μl/min or more. At such flow rates, it has further been found that the influence of temperature on the results is rather limited. Similarly good results (significant reduction of red blood cells in plasma even when using whole blood) were obtained with temperatures varying between approximately 23° and 50° Celsius.

Although most examples of the present invention relate to fluid dispersions composing of blood, the invention is not limited to such fluid dispersions. The invention is also applicable to other biological fluid dispersions and also to non-biological fluid dispersions. Non-biological applications may, for example, include separating particles in chemical process streams.

Other embodiments of the invention will be appreciated by those skilled in the art from consideration of the specification and practice of the invention. Furthermore, certain terminology has been used for the purpose of descriptive clarity, and not to limit the present invention. The embodiments and preferred features described above should be considered exemplary, with the invention being defined by the appended claims.

What is claimed is:

1. A device for separating particles in a fluid dispersion comprising:
an inlet channel and an outlet channel adjoined to one another by a constriction channel, the inlet, outlet and constriction channels configured to create at a junction of the outlet and constriction channels a fluid dispersion flow having a first flow region and a second flow region, the second flow region having a lower concentration of particles than the first flow region; and
a collection channel located at the junction of the constriction channel and the outlet channel and having an inlet located within the second flow region of the fluid flow.

2. The device of claim 1 wherein the inlet, outlet, constriction and collection channels have first, second, third and fourth cross-sectional areas, respectively, the third cross-sectional area being substantially smaller than the first and second cross-sectional areas.

3. The device of claim 2 wherein the outlet channel comprises an inlet at the junction, the inlet having first and second circumferentially-spaced wall portions, the outlet channel fluid dispersion flow entry point being at or near the first wall portion, the inlet to the collection channel residing in the second wall portion.

4. The device of claim 3 wherein the inlet to the collection channel resides at the outlet channel inlet at a maximum circumferentially-spaced position from the fluid dispersion flow entry point.

5. The device of claim 1 wherein the outlet channel has a longitudinal axis, the collection channel having an inlet segment coextensive to the collection channel inlet and being non-parallel to the longitudinal axis of the outlet channel.

6. The device of claim 5 wherein the inlet segment has a slope of between about 45 degrees to about 135 degrees.

7. The device of claim 1 wherein the outlet channel comprises an inlet at the junction having a transverse face, the outlet channel fluid dispersion flow entry point and collection channel inlet located in the transverse face.

8. The device of claim 7 wherein the outlet channel comprises first and second circumferentially-spaced wall portions adjoining the transverse face of the inlet, the outlet channel fluid dispersion flow entry point being at or near the first wall portion, the inlet to the collection channel residing at or near the second wall portion.

9. The device of claim 7 wherein the inlet to the collection channel is at a maximum distance from the fluid dispersion flow entry point in the transverse face.

10. The device of claim 7 wherein the outlet channel has a longitudinal axis, the collection channel having an inlet segment coextensive to the collection channel inlet and being non-parallel to the longitudinal axis of the outlet channel.

11. The device of claim 1 wherein the inlet channel comprises a converging segment at the inlet to the constriction.

12. The device of claim 1 wherein the inlet, outlet, constriction and collection channels are formed within a substrate, the device comprising a device for controlling the temperature of the substrate.

13. The device of claim 1 wherein the ratio of the cross-sectional areas of the outlet channel to the constriction channel is between about 10.0 and about 30.0.

14. The device of claim 1 wherein the ratio of the cross-sectional areas of the inlet channel to the constriction channel is between about 5.0 and about 20.0.

15. The device of any of claim 1 wherein the ratio of the cross-sectional areas of the outlet channel to the collection channel is between about 2.0 and about 20.0.

16. The device of claim 1 wherein the ratio of the cross-sectional areas of the outlet channel to the constriction channel is between about 10.0 and about 30.0, the ratio of the cross-sectional areas of the inlet channel to the constriction channel is between about 5.0 and about 20.0, and the ratio of the cross-sectional areas of the outlet channel to the collection channel is between about 2.0 and about 20.0.

17. The device of claim 1 further comprising a collection channel located in the second flow region.

18. The device of claim 1 wherein the fluid dispersion is blood and the particles comprise plasma and blood cells.

19. The device of claim 1 wherein the inlet channel, constriction channel, outlet channel and collection channel comprise a separating unit, the device having a plurality of separating units.

20. The device of claim 1 wherein the constriction channel, outlet channel and collection channel comprise a unit, the device comprising a plurality of units each coupled to the inlet channel.

21. A method of separating particles from a fluid dispersion comprising:
directing the fluid dispersion successively through an inlet channel, a constriction channel and an outlet channel to create at a junction of the outlet and constriction channels a fluid dispersion flow having a first flow region and a second flow region, the second flow region having a lower concentration of particles than the first flow region; and
collecting at least a part of the fluid in the second flow region in a collection channel located at the junction of the constriction channel and the outlet channel.

22. The method of claim 21 wherein the fluid dispersion is blood and the particles comprise plasma and blood cells, the second flow region being substantially free of red blood cells.

23. The method of claim 22 wherein the fluid dispersion temperature is maintained at between about 30° C. and about 50° C.

24. The method of claim 22 wherein the fluid dispersion temperature is maintained at between about 35° C. and about 45° C.

25. The method of claim 22 wherein the flow rate of the fluid dispersion is between about 30 μL/min and about 190 μL/min.

26. The method of claim 22 wherein the flow rate of the fluid dispersion is between about 30 μL/min and about 100 μL/min.

27. The method of claim 22 wherein the hematocrit of the blood is reduced prior to entering the constriction channel.

28. The method of claim 27 wherein the hematocrit is reduced to about 30% to about 20%.

29. A device for separating particles in a first fluid dispersion comprising:
an inlet channel and a flow separation channel adjoined to one another by a first constriction channel, the inlet, flow separation and first constriction channels configured to create at a junction of the flow separation and constriction channels a second fluid dispersion flow having a first dilute flow region and a first concentrate flow region, the first dilute flow region having a lower concentration of particles than the first concentrate flow region, the flow separation channel having a first dilute channel for receiving at least a portion of the first dilute flow and a concentrate channel for receiving at least a portion of the first concentrate flow, the dilute channel having an outlet,
a second constriction adjoining the outlet of the first dilute channel with a first outlet channel, the first dilute channel, first outlet and second constriction channels configured to create at a junction of the first outlet and second constriction channels a third fluid dispersion flow having a second dilute flow region and a second concentrate flow region, the second dilute flow region having a lower concentration of particles than the second concentrate flow region; and
one or more collection channels having inlets located in the second dilute flow region.

30. The device of claim 29 wherein at least one of the first collection channel inlets is located at the second junction.

31. The device of claim 29 further comprising one or more collection channels having inlets located within the first dilute flow region.

32. The device of claim 29 wherein the flow separation channel comprises a second dilute channel for receiving at least a portion of the first dilute flow, the second dilute channel having an outlet, the device further comprising a third constriction adjoining the outlet of the second dilute channel with a second outlet channel, the second dilute channel, second outlet and third constriction channels configured to create at a junction of the second outlet and third constriction channels a fourth fluid dispersion flow having a third dilute flow region and a third concentrate flow region, the third dilute flow region having a lower concentration of particles than the third concentrate flow region; and
one or more collection channels having inlets located within the third dilute flow region.

33. The device of claim 32 further comprising one or more collection channels having inlets located within the first dilute flow region.

34. A method of separating particles from a first fluid dispersion comprising:
directing the fluid dispersion successively through an inlet channel, a first constriction channel and a separation channel to create at a junction of the separation and first constriction channels a second fluid dispersion flow having a first dilute flow region and a first concentrate flow region, the first dilute flow region having a lower concentration of particles than the first concentrate flow region, the flow separation channel having a first dilute channel for receiving at least a portion of the first dilute flow and a concentrate channel for receiving at least a portion of the first concentrate flow, the dilute channel having an outlet;
directing at least a portion of the first dilute flow successively through the dilute channel, a second constriction channel and an outlet channel to create at a junction of the outlet and second constriction channels a third fluid dispersion flow having a second dilute flow region and a second concentrate flow region, the second dilute flow region having a lower concentration of particles than the second concentrate flow region; and
collecting at least a portion of the second dilute flow in one or more collection channels located within the second dilute flow region.

35. The method of claim 34 further comprising collecting at least a portion of the first dilute flow in one or more collection channels located within the first dilute flow region.

36. The method of claim 34 wherein the fluid dispersion is blood and the particles comprise plasma and blood cells.

37. The method of claim 36 wherein the blood is unprocessed blood taken from a patient.

38. The method of claim 36 wherein the hematocrit of the blood in the first dilute channel is lower than the hematocrit of the first fluid dispersion.

39. The method of claim 36 wherein the hematocrit in the first dilute channel is between about 0% and about 30%.

40. The method of claim 36 wherein the hematocrit in the first dilute channel is between about 0% and about 20%.

41. A method of separating particles in a fluid dispersion comprising:
receiving a fluid dispersion flow and creating a first diluted fluid dispersion flow using both the Fahraeus effect and Zweifach-Fung effect,
removing any remaining unwanted particles within the first diluted fluid dispersion flow to create a second fluid dispersion flow using both the Fahraeus and Zweifach-Fung effect; and
collecting at least a portion of the second fluid dispersion flow.
